(19) United States
(12) Patent Application Publication
(10) Pub. No.: US 2021/0245396 A1
(43) Pub. Date: Aug. 12, 2021

(54) Cutting Chain for Cutting Mineral or Metallic Materials

(71) Applicant: Andreas Stihl AG & Co. KG, Waiblingen (DE)

(72) Inventor: Matthias Schulz, Freiberg (DE)

(21) Appl. No.: 17/168,381

(22) Filed: Feb. 5, 2021

(30) Foreign Application Priority Data
Feb. 12, 2020 (EP) 20 156 887.0

(51) Int. Cl. B28D 1/12

(52) U.S. Cl. CPC B28D 1/124; B28D 1/082

(57) ABSTRACT

A cutting chain for cutting mineral or metallic materials has central drive links with a projection. Pairs of two side members are positioned laterally at the central drive links. The central drive links and the side member pairs are pivotably connected to each other. At least two cutting members are arranged sequentially in running direction of the cutting chain and each have one pair of side members and an abrasive cutting element connecting the two side members to each other. A drive link is arranged between the two cutting members and the projection of the drive link projects into a space between the cutting elements. The cutting chain has a cutout arranged such that a maximum sag of the cutting chain, at which the projection of the drive link comes into contact with one of the cutting elements, is enlarged compared to the same cutting chain without cutout.

### BACKGROUND OF THE INVENTION

The invention relates to a cutting chain for cutting mineral or metallic materials, wherein the cutting chain comprises central drive links and lateral side members arranged in pairs, wherein the central drive links and the lateral side members are connected pivotably to each other to pivot about pivot axes. The cutting chain comprises at least two cutting members arranged sequentially in a running direction, wherein each cutting member is formed by two side members of a pair and a cutting element for abrasive material removal that connects the two side members of the pair to each other. The drive link comprises a projection that projects between the two cutting elements arranged sequentially in the running direction. The cutting chain comprises a transverse direction extending parallel to the pivot axis, and the cutting chain comprises a pivot axis plane which connects the pivot axes of the cutting chain when the cutting chain is pulled straight (stretched position).

US 2013/0319201 A1 discloses a cutting chain for cutting metallic or mineral materials. Cutting elements are provided for material removal. When looking at a cutting element, each cutting element has a leading projection and a trailing projection arranged thereat; each projection is arranged at a drive link.

The length of the cutting elements is delimited by the required distance in relation to the leading and trailing projections. For a smooth running of the chain at the workpiece, a distance as small as possible is desirable between the projection and the cutting element or a support section of a connecting link. However, it has been found that a contact that may occur between the projection and the cutting element when the chain is sagging causes an increased mechanical load of the connecting stud and thereby the service life of the cutting chain is reduced.

The invention has the object to provide a cutting chain of the aforementioned kind which exhibits a calm running behavior during cutting and a long service life.

### SUMMARY OF THE INVENTION

This object is solved by a cutting chain that comprises at least one cutout that is arranged and configured such that the maximum sag of the cutting chain, at which the projection comes into contact with the cutting element, is enlarged compared to the same cutting chain that is not provided with such a cutout.

The invention provides at least one cutout at the cutting chain wherein the at least one cutout is arranged and configured in such a way that the maximum sag of the cutting chain at which the cutting element and the projection come into contact with each other is enlarged compared to the same cutting chain without such a cutout. The cutout enables a large length of the cutting elements or a minimal spacing between cutting element and projection; the cutout enlarges thus the possible sag of the cutting chain compared to a comparative cutting chain without a cutout. The enlarged maximum sag reduces the risk that the projection comes into contact with the cutting element; the enlarged maximum sag increases in this way the service life of the cutting chain. In this context, the maximum sag is in particular configured such that, in usual operation, no contact between cutting element and projection occurs. The minimal distance between cutting element and projection effects a smooth running of the cutting chain.

Particularly advantageous is the arrangement of the at least one cutout in a cutting chain in which the projection projects into a space between two cutting members which are supported on a common drive link. In such a cutting chain, the projection is flanked at both sides by cutting elements so that the drive link when the projection contacts one of the cutting elements cannot escape in the opposite direction toward the other cutting element.

Advantageously, the projection, in relation to the running direction of the cutting chain, is arranged centrally between the pivot axes of the drive link. In an advantageous configuration, the projection is embodied symmetrical to a transverse plane of the drive link, wherein the transverse plane is centrally positioned between the pivot axes of the drive link and perpendicularly to the running direction.

In a first embodiment variant, it is provided that the cutout is arranged at an end face of the cutting element, wherein the end face extends in transverse direction of the cutting chain. The transverse direction of the cutting chain is in this context the direction extending parallel to the pivot axes of the cutting chain. Due to the cutout provided at the end face, the projection can dip into the cutout of the cutting element at the end face of the cutting element when the cutting chain is sagging so that the possible maximum sag at which a contact between projection and cutting element occurs is enlarged. Preferably, the cutout of the cutting element extends to the top side of the cutting element that is positioned remote from the pivot axis plane or positioned remote from a drive tooth of the neighboring drive link.

In an alternative embodiment, it is advantageously provided that the cutout is embodied at a projection. When the cutting chain is sagging, the cutting element can dip partially into the cutout at the projection. In this way, the maximum sag at which projection and cutting element come into contact with each other is also enlarged. Preferably, the cutout is positioned at least partially in that half of the projection which is closer to the pivot axis plane. Preferably, the cutout extends to a location close to the base line of the projection.

It can also be provided that the cutting chain comprises a cutout at a projection as well as a cutout at a cutting element.

In order to achieve a smooth running of the cutting chain, it is advantageously provided that the cutting element is embodied as long as possible. The length of the cutting element measured in the running direction is advantageously larger than the division of the cutting chain. In this context, the division is defined as the distance, divided by 2, of a pivot axis to the next but one pivot axis. The distance between neighboring pivot axes must not be identical in this context. Preferably, the length of the cutting element measured in the running direction amounts to at least 1.05 times the length of the division, in particular at least 1.1 times, particularly preferred at least 1.2 times the length of the division.

The cutting member comprises advantageously a central section which extends from one pivot axis to the next pivot axis in the running direction. The central section is therefore a length section of the cutting member. The cutting element extends in the running direction advantageously to a point in front of the central section and to a point behind the central section. The length of the cutting element is therefore larger than the length of the central section.

The cutting element comprises advantageously a base body which is fixed at the side members. The base body forms preferably the carrier for the cutting material. Advantageously, the base body is comprised of steel. The base body can be produced advantageously by a sintering process. However, it can also be provided that the base body is milled.

The base body is advantageously connected to the side members by soldering or welding, in particular by means of laser.

The side members and the drive links are advantageously pivotably connected to each other by studs. The studs are in particular formed as collar studs. The collar of the collar studs are preferably arranged between the side members of a pair.

An independent concept according to the invention concerns the configuration of a cutting chain with smooth running and simple manufacture. In order to enable a simple manufacture of the cutting member, it is advantageously provided that the cutting element comprises at least a centering section that secures the position of the base body in relation to at least one side member in at least one direction parallel to the pivot axis plane. The at least one centering section is advantageous independent of the presence of at least one cutout for enlarging the maximum sag of the cutting chain. When manufacturing the cutting chain, the base body can be positioned simply at the at least one side member due to the at least one centering section and subsequently can be fixed at the at least one side member. The centering section enables a comparatively flat configuration of the base body. When manufacturing the cutting chain, the base body is advantageously positioned at the side members in an automated fashion by means of at least one gripping device. For an exact positioning, the base body must have a minimum size at its surfaces that are to be gripped. Due to at least one centering section, positioning by the gripping device can be carried out in a less exact fashion so that the size of the surface to be gripped and thus the height of the base body, compared to a base body without a centering section, can be reduced. In this way, a smooth running of the cutting chain is provided.

The centering section determines the position of the base body in relation to at least one side member advantageously in the transverse direction. The centering section projects in this context advantageously into a space between the side members. In this way, centering of the cutting element in the transverse direction can be achieved in a simple manner. Alternatively or additionally, it is advantageously provided that the cutting element comprises at least one centering section which determines the position of the base body in relation to at least one side member in the running direction. The centering section projects in this context advantageously into a recess provided on at least one side member. In this way, centering in the longitudinal direction can be achieved in a simple manner. Particularly advantageously, at least one centering section for determining the position of the base body in relation to at least one side member in the running direction and at least one centering section for determining the position of the base body in relation to at least one side member in the transverse direction are provided. In particular, at least one centering section for determining the position of the base body in relation to at least one side member is provided in the running direction as well as in transverse direction. Preferably, the at least one centering section determines the position of the base body in the running direction and/or in the transverse direction in relation to both side members of a pair.

The cutting material is comprised preferably of a diamond layer. Particularly preferred, a single layer of diamond is provided as a cutting material. The diamond layer is applied to the base body in this context. In an alternative advantageous embodiment, the cutting material is embedded in the base body. The cutting material is in particular in the form of diamonds embedded in the base body. Preferably, a base body with embedded diamonds is produced in a sintering process.

The maximum distance of the cutting element to the pivot axis plane amounts advantageously to less than 1.4 times the length of the division of the cutting chain. The maximum distance of the projection to the pivot axis plane amounts in particular to 0.8 to 1 times the maximum distance of the cutting element to the pivot axis plane. The projection therefore does not project past the cutting element.

### BRIEF DESCRIPTION OF THE DRAWING

Embodiments of the invention will be explained in the following in more detail with the aid of the drawing.

FIG. 1 is a side view of a concrete cutter.

FIG. 2 is a schematic side view of a guide bar with a partially illustrated cutting chain arranged thereat and a drive sprocket.

FIG. 3 is a side view of a section of a first embodiment of the cutting chain.

FIG. 4 is a plan view of the section of the cutting chain of FIG. 3 in the direction of arrow IV in FIG. 3.

FIG. 5 is view in the direction of arrow V in FIG. 3.

FIG. 6 is a schematic section illustration of the cutting chain in the region of the collar stud.

FIG. 7 is a side view of a section of a further embodiment of the cutting chain.

FIG. 8 is a plan view of the section of the cutting chain of FIG. 7 in the direction of arrow VIII in FIG. 7.

FIG. 9 is a view in the direction of arrow IX of FIG. 7.

FIG. 10 is a side view of a section of a further embodiment of the cutting chain.

FIG. 11 is a plan view in the direction of arrow XI in FIG. 10.

FIG. 12 is a view in the direction of arrow XII in FIG. 10.

FIG. 13 is a detail illustration of the cutting chain of FIGS. 10 to 12 showing the cutting element in an illustration separate from the side members.

FIG. 14 is a perspective illustration of the section of the cutting chain of FIG. 13 with separately illustrated cutting element.

FIG. 15 is another perspective illustration of the section of the cutting chain of FIG. 13 with separately illustrated cutting element.

FIG. 16 is a perspective illustration of the cutting element of the embodiment of FIGS. 10 through 15.

FIG. 17 is a side view of the cutting element of FIG. 16.

FIG. 18 is a bottom view in the direction of arrow XVIII in FIG. 17.

FIG. 19 is an end view in the direction of arrow XIX in FIG. 17.

### DESCRIPTION OF PREFERRED EMBODIMENTS

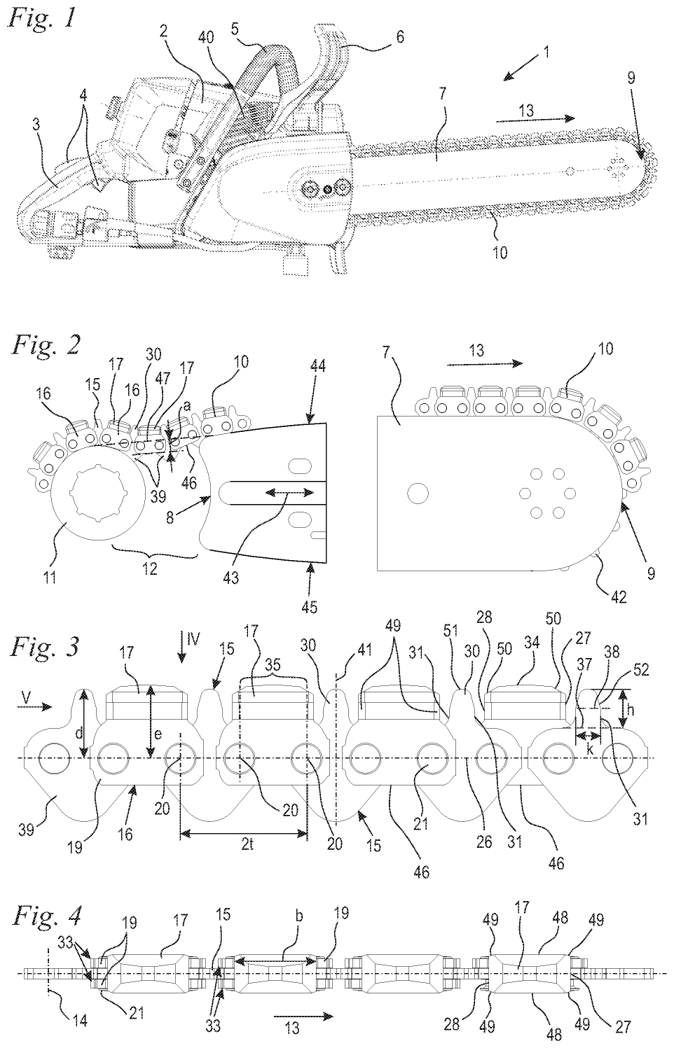

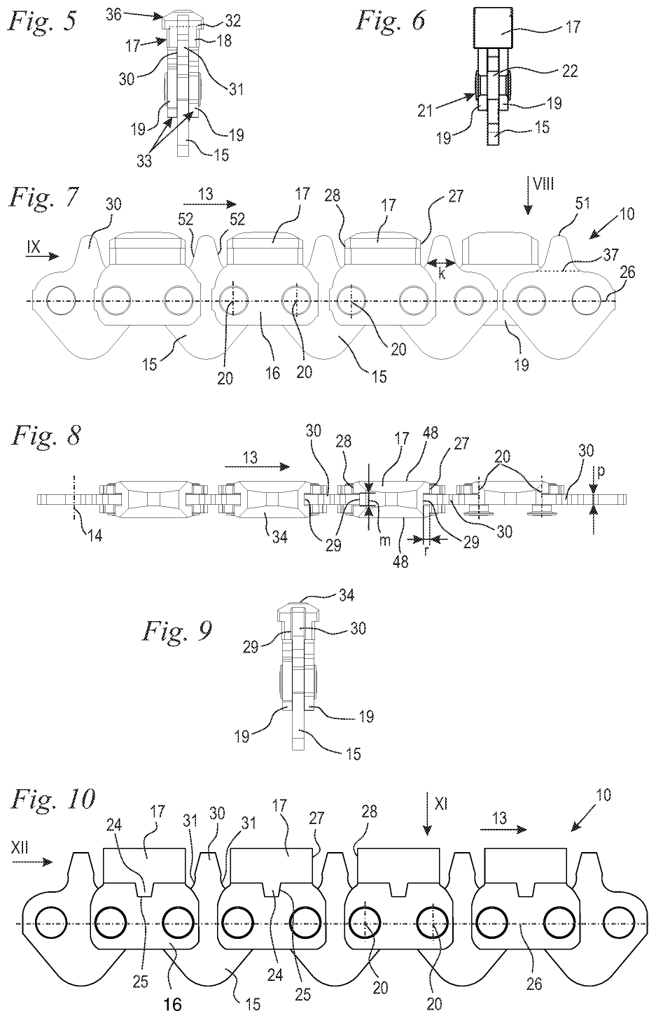

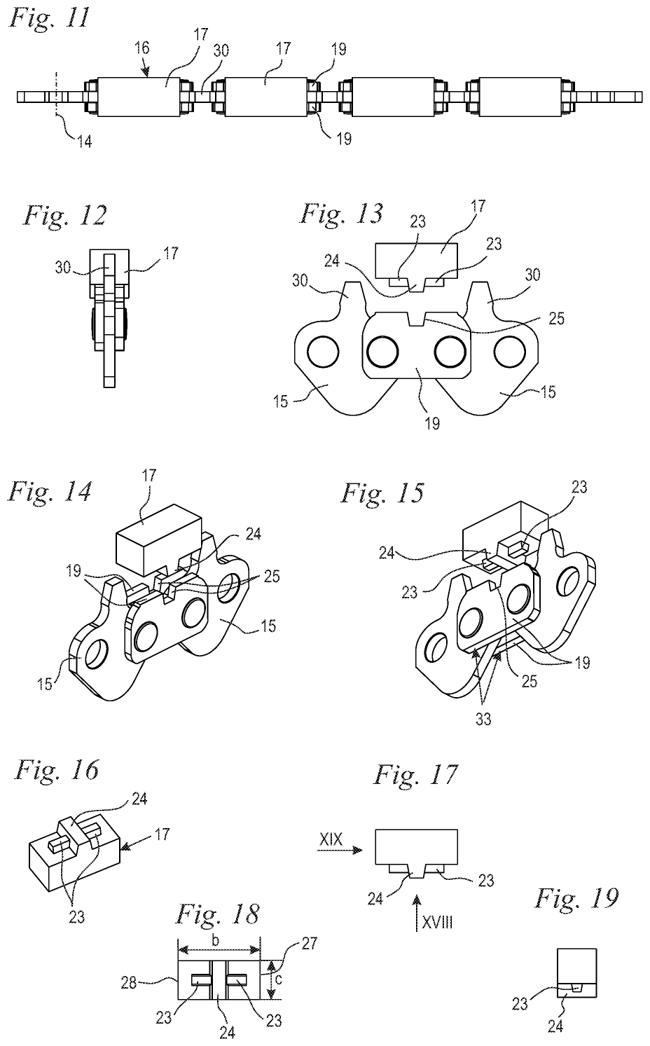

FIG. 1 shows a concrete cutter 1 designed for cutting metallic or mineral materials such as concrete or steel. The concrete cutter 1 comprises a housing 2 at which a rear handle 3 as well as a front handle 5 for guiding the concrete cutter 1 in operation are secured. At the rear handle 3, operating elements 4, for example, a throttle lever and a throttle lever lock are arranged. At the housing 2, a guide bar 7 is secured which projects forwardly at the end of the housing 2 opposite the rear handle 3. A cutting chain 10 is arranged circumferentially around the guide bar 7. A hand guard 6 is arranged at the side of the front handle 5 facing the guide bar 7. In the housing 2, a drive motor 40 is arranged which drives the cutting chain 10 in a running direction 13 circumferentially about the guide bar 7. The drive motor 40 is advantageously a single cylinder engine. The drive motor 40 can be an internal combustion engine, in particular a two-stroke engine or a mixture-lubricated four-stroke engine. It can however also be provided that the drive motor 40 is an electric motor that is supplied with energy by a power cable or by a rechargeable battery.

The guide bar 7 has a first end 8, not visible in FIG. 1 but illustrated in FIG. 2, with which the guide bar 7 is fixed at the housing 2. At a second free end 9 of the guide bar 7, the cutting chain 10 is deflected. In the embodiment, a sprocket 42 is provided for this purpose.

The drive motor 40 drives a drive wheel 11 illustrated in FIG. 2. The cutting chain 10 is guided across the drive wheel 11 and projects with drive teeth 39 into the drive wheel 11. The drive wheel 11 entrains the drive teeth 39 and drives the cutting chain 10 in this way in the running direction 13. The cutting chain 10 is driven at a first longitudinal side 44 of the guide bar 7 in the direction from the first end 8 to the second end 9 of the guide bar 7 and is driven at the second oppositely positioned longitudinal side 45 from the second end 9 to the first end 8. In the position of the concrete cutter 1 illustrated in FIG. 1 in which the concrete cutter 1 is placed on a support surface, the first longitudinal side 44 is extending at the top side of the guide bar 7 and the second longitudinal side 45 at the bottom side of the guide bar 7.

The cutting chain 10 comprises drive links 15 and cutting members 16 which are connected to each other in a pivotable manner. The cutting members 16 have guide surfaces 46 with which the cutting members 16 rest against the guide bar 7 and the drive wheel 11. Between the drive wheel 11 and the first end 8 of the guide bar 7, an intermediate space 12 is formed in which the cutting chain 10 is freely suspended. In FIG. 2, a tangent 47 to the drive wheel 11 and to the guide bar 7 is illustrated in the intermediate space 12. In relation to this tangent 47, the cutting chain 10 sags with its guide surface 46. This causes the cutting chain 10 to bend in relation to the longitudinal side 44 such that, in forward direction, the distance between cutting elements 17 and projections 30 is reduced. The magnitude of the sag depends on the position of the guide bar 7 in relation to the drive wheel 11. In FIG. 2, a maximum sag a is illustrated at which the projections 30 and cutting elements 17 contact each other. The projections 30 and the cutting elements 17 will be explained in more detail in the following. In order to be able to tension the cutting chain 10, the position of the guide bar 7 is adjustable in a conventional manner in the direction of double arrow 43, i.e., in the longitudinal direction of the guide bar 7, in relation to the housing 2.

FIGS. 3 to 5 show the configuration of the cutting chain 10 in detail. The cutting chain 10 comprises side members 19 and drive links 15 which are connected pivotably to each other about pivot axes 20. In this context, two side members 19 are arranged in pairs adjacent to each other and form a pair 33 of side members 19, respectively. Two drive links 15 project into a space between two side members 19 of a pair 33. In this context, a first drive link 15 is connected pivotably to the two side members 19 about a first pivot axis 20 and the second one of the two drive links 15 is connected pivotably about a second pivot axis 20 to the two side members 19. In a transverse orientation 14 which is parallel to the pivot axes 20, the drive link 15 is arranged between the side members 19 of a pair 33. As illustrated in particular in FIG. 4, two side members 19 are connected to each other by means of a cutting element 17, respectively. The two side members 19 of the pair 33 and the cutting element 17 form together a cutting member 16.

As also shown in FIGS. 3 and 4, the projections 30 are formed at the drive links 15, respectively. The drive links 15 are formed as a one-piece flat sheet metal part. Each drive link 15 comprises in the embodiment precisely one projection 30. The projections 30 project into a space between sequentially arranged cutting elements 17 in the running direction 13. In the embodiment, almost every side member 19 is part of a cutting member 16. Advantageously, at least one pair 33 of side members 19 is configured as a closure member without a cutting element 17. However, it can also be provided that in the running direction 13 only every other or every third pair 33 of side members 19 supports a cutting element 17. Side members 19 that do not support a cutting element 17 can comprise support elements.

The drive links 15 and side members 19 are connected to each other in a pivotable manner by collar studs 21. The cutting chain 10 comprises a division t. The division t corresponds to half the distance of a pivot axis 20 to the next but one pivot axis 20. FIG. 3 illustrates the doubled distance t, i.e., 2t, as the distance of a pivot axis 20 to the next but one pivot axis 20. As also illustrated in FIG. 3, each cutting member 16 comprises a central section 35. The central section 35 extends in the running direction 13 from the first pivot axis 20 to the second pivot axis 20 of the cutting member 16. The central section 35 is therefore a length section of a cutting member 16. As illustrated in FIG. 3, the cutting element 17 projects past the central section 35 in the running direction 13 as well as opposite to the running direction 13.

As also shown in FIG. 3, the guide surfaces 46 are provided at the side members 19, respectively, in particular at the side of the side members 19 facing away from the cutting element 17. In the illustrations of FIGS. 3 and 4, the side member 19 in the foreground is not shown for the cutting member 16 illustrated to the right in the illustrations.

FIG. 3 shows also the configuration of the projections 30 in detail. In the embodiment, each drive link 15 comprises a projection 30. During cutting, the projections 30 can support themselves at the bottom of the kerf and effect in this way a more uniform running of the cutting chain 10. For this purpose, the projections 30 comprises a top side 51. The top side 51 of the projections 30 is positioned so as to face away from a pivot axis plane 26. The pivot axis plane 26 is the plane which is defined by the pivot axes 20 in case of a stretched (pulled straight) cutting chain 10. The projections 30 have slanted flanks 52. At each one of the flanks 52, a cutout 31 is arranged in the embodiment. At the cutouts 31, the width k of the projections 30 measured in the running direction 13 is reduced compared to a projection 30 with straight flanks 52.

As shown in FIG. 3, the projection 30 has a height h measured perpendicularly to the pivot axis plane 26. The height h is measured from a base line 37 to the top side 51. The base line 37 corresponds to the extension of the top edge of the drive link 15 in a leading and a trailing direction in relation to the projection 30. The cutouts 31 are at least partially, preferably completely, arranged in that half of the projection 30 that is closer to the pivot axis plane 26. In FIG. 3, a centerline 38 is illustrated which extend centrally between the top side 51 and the base line 37 and extends parallel to the base line 37. In the embodiment, the cutouts 31 are arranged completely between the base line 37 and the centerline 38. In the embodiment, the width k of the projection 30 does not increase constantly away from the centerline 38 toward the base line 37 but remains constant across a region or decreases in the direction toward the base line 37. In this way, the cutouts 31 are formed.

As also shown in FIG. 3, the projection 30 is mirror-symmetrical to a transverse plane 41. The transverse plane 41 extends perpendicularly to the running direction 13 and parallel to the pivot axes 20 centrally between the two pivot axes 20 of a drive link 15. The projection 30 is arranged centrally at the drive link 15 in relation to the running direction 13. In the embodiment, all drive links 15 are identically configured. The top side 51 of the projection 30 comprises a distance d in relation to the pivot axis plane 26.

The cutting element 17 comprises a top side 34. The top side 34 is the side of the cutting element 17 which is remote from the pivot axis plane 26. With its top side 34, the cutting element 17 removes material at the base of the kerf during cutting. The cutting element 17 comprises a maximum distance e to the pivot axis plane 26. The distance e amounts advantageously to less than 1.4 times the division t of the cutting chain 10. In the embodiment, the distance e is measured in relation to the top side 34. The distance d amounts advantageously to 0.8 to 1 times the maximum distance e of the cutting element 17 to the pivot axis plane 26. In order to achieve good support and smooth running of the cutting chain 10 in operation, the cutting chain 10 comprises bevels 49 and 50. The bevels 50, illustrated in FIG. 3, are arranged at the top side 34 of the cutting element 17 adjacent to the first end face 27 and adjacent to the second end face 28. In this context, the first end face 27 of the cutting element 17 is the leading end face in the running direction 13 and the second end face 28 is the trailing end face in the running direction 13. The end faces 27 and 28 extend in the transverse direction 14 of the cutting chain 10 that is illustrated in FIG. 4.

The bevels 49 are illustrated in FIG. 4. The cutting element 17 comprises two oppositely positioned side walls 48 extending approximately in the running direction 13. In operation, the side walls 48 extend at the sidewalls of the kerf. Bevels 49 are formed, respectively, at the side walls 48 adjacent to the first end face 27 and adjacent to the second end face 28. Due to the bevels 49 and 50, approximately a ball shape of the cutting elements 17 is provided. Instead of the bevels 49 and 50, also rounded contours for the side walls 48 and/or the top side 34 can be provided.

In FIG. 4, also the length b of the cutting element 17 is illustrated. The length b is advantageously larger than the division t of the cutting chain 10. The length b amounts advantageously to at least 1.05 times the length of the division t. Advantageously, the length b amounts to at least 1.1 times, preferably at least 1.2 times, the length of the division t of the cutting chain 10.

In FIG. 5, the configuration of the cutting element 17 is schematically illustrated. The cutting element 17 comprises a base body 18. The base body 18 is comprised advantageously of steel. The base body 18 can advantageously be produced by sintering or by milling. The base body 18 carries a layer 32 with abrasive particles. The layer 32 forms the cutting material 36 of the cutting element 17. Preferably, the layer 32 is comprised of diamonds. The layer 32 is advantageously a single layer of diamonds. The base body 18 is preferably connected by welding to the side members 19. Alternatively, it can also be provided that the base body 18 is secured by soldering to the side members 19. An attachment by means of a laser method is particularly preferred. In an alternative configuration, it can be provided that the cutting material is embedded in the base body. In this case, the material of the base body is also removed during cutting. For example, diamonds can be embedded in the base body. The base body with embedded cutting material can be produced advantageously by a sintering method.

FIG. 6 shows schematically the configuration of the collar stud 21. The cutting element 17 is only schematically illustrated in this context. The stud 21 comprises a collar 22 which is arranged in the region of the drive link 15. The collar 22 does not extend into the lateral side members 19. In the region of the side members 19, the collar stud 21 has a reduced diameter compared to the region that projects through the drive link 15. In this way, the axial position of the side members 19 in relation of the drive link 15 is structurally determined.

FIGS. 7 to 9 show a further embodiment of a cutting chain 10. In the embodiment, all side members 19 are connected to each other by cutting elements 17 with the exception of a possibly existing closure member. However, it can also be provided that some of the side members 19 do not support a cutting element 17 and in particular are embodied as support elements. The projection 30 projects into the space between two cutting members 16 whose side members 19 are pivotably supported at a common drive link 15. This drive link 15 carries the projection 30 that projects into the space between the two cutting elements 17 arranged sequentially in the running direction 13. In the embodiment, both flanks 52 of the projection 30 are embodied with a slant. The width k of the projection 30 increases from the top side 51 to the base line 37. The flanks 52 extend straight—aside from rounded portions at the top side 51 and the base line 37—from the top side 51 to the base line 37.

In order to enlarge the maximum sag a (FIG. 2), the cutting elements 17 comprises cutouts 29 at their end faces 27 and 28, as illustrated in FIG. 8. The cutouts 29 extend between the side walls 48 and do not project into the side walls 48. The width m of the cutouts 29 is slightly larger than the thickness p of the projections 30. The width m of the cutouts 29 and the thickness p of the projections 30 are measured in the transverse direction 14 in this context. In the embodiment, the thickness p of the projections 30 corresponds to the thickness of the drive links 15. The cutouts 29 have a depth r measured in the running direction. The depth r can amount advantageously to 0.3 times to 2 times the width m of the cutout 29. As shown in particular in FIG. 9, the projection 30 and the cutout 29 are positioned such that the projection 30 can dip into the cutout 29. In this way, the maximum sag a of the cutting chain 10 is enlarged. In the embodiment, the projection 30 and the cutout 29 are arranged in the transverse direction 14 centrally at the cutting chain 10. The cutouts 29 extend in the embodiment across the entire height of the cutting element 17. The cutouts 29 extend in particular to the top side 34, as shown in FIG. 9.

FIG. 10 shows a further embodiment of the cutting chain 10 whose configuration corresponds substantially to the configuration of the cutting chain 10 of FIGS. 2 to 5. The projections 30 have cutouts 31. The end faces 27 and 28 of the cutting elements 17 are embodied without cutouts. Cutouts 29 can be arranged at the end faces 28 and 27 as an alternative or in addition. The cutting elements 17 in this context are illustrated schematically without the bevels 49 and 50. Also, the layer 32 is not illustrated. The cutting elements 17 have a centering section 24 which projects respectively into a recess 25 of the side member 19. By means of the centering section 24, the position of the cutting element 17 in relation to the side members 19 of a pair 33 is fixed in the running direction 13.

The cutting element 17, as shown in particular in FIG. 15, also comprises centering sections 23 which secure the position of the cutting element 17 in the transverse direction 14. The centering sections 23 in relation to the running direction 13 are arranged in the embodiment in front of and behind the centering section 24. Also, only one centering section 23 can be advantageous. The centering sections 23 project into the space between the two side members 19 of the cutting member 16 and in this way secure the position of the cutting element 17 in relation to the two side members 19 of the pair 33 in transverse direction 14 of the cutting member 16.

The configuration of the cutting element 17 with the centering sections 23 and 24 is illustrated in detail in FIGS. 16 to 19. The centering section 24 extends across the entire width c of the cutting element 17 measured in the transverse direction 14 (FIG. 11). The centering sections 23 have a distance from the end faces 27 and 28. The length of the centering sections 23 is less than the length b of the cutting element 17. As illustrated in FIGS. 16, 17, and 19, the height of the centering sections 23 is also less than that of the centering section 24.

The centering sections 23 and 24 facilitate positioning of the cutting element 17 at the side members 19 before the cutting elements 17 are fixed at the side members 19, for example, by soldering or by welding. In this way, the manufacture of the cutting chain 10 is simplified. The cutting element 17 can be embodied with minimal height because only an automated pre-positioning is required that is possible also with small surfaces to be gripped. The minimal height of the cutting element 17 leads to a smooth running of the cutting chain 10.

The specification incorporates by reference the entire disclosure of European priority document 20 156 887.0 having a filing date of Feb. 12, 2020.

While specific embodiments of the invention have been shown and described in detail to illustrate the inventive principles, it will be understood that the invention may be embodied otherwise without departing from such principles.

What is claimed is:

1. A cutting chain for cutting mineral or metallic materials, the cutting chain comprising:
central drive links each comprising a projection;
pairs of two side members, respectively, wherein the two side members of the pairs of two side members are positioned laterally in relation to the central drive links, wherein the central drive links and the pairs of two side members are pivotably connected to each other so as to pivot about pivot axes, wherein the cutting chain comprises a transverse direction extending parallel to the pivot axes and further comprises a pivot axis plane connecting the pivot axes of the cutting chain when the cutting chain is pulled straight;
at least two cutting members arranged sequentially in a running direction of the cutting chain, wherein each of the at least two cutting members comprises one of the pairs of two side members and further comprising a cutting element configured to abrasively remove material, wherein the cutting element connects the two side members of the pair of two side members to each other;
wherein the central drive links include a drive link arranged between the at least two cutting members, wherein the projection of the drive link arranged between the at least two cutting members projects into a space between the cutting elements of the at least two cutting members;
wherein the cutting chain comprises at least one cutout arranged and configured such that a maximum sag of the cutting chain, at which the projection of the drive link arranged between the at least two cutting members comes into contact with one of the cutting elements of the at least two cutting members, is enlarged in comparison to the same cutting chain without such a cutout.

2. The cutting chain according to claim 1, wherein the at least two cutting members between which the projection of the drive link arranged between the at least two cutting members projects are supported on the same one of the central drive links.

3. The cutting chain according to claim 1, wherein the cutout is arranged at an end face of one of the cutting elements of the at least two cutting members, wherein the end face is extending in the transverse direction of the cutting chain.

4. The cutting chain according to claim 3, wherein the cutout arranged at the end face extends to a top side of said one cutting element, wherein the top side is remote from the pivot axis plane.

5. The cutting chain according to claim 1, wherein the cutout is formed at the projection of the drive link arranged between the at least two cutting members.

6. The cutting chain according to claim 5, wherein the cutout is arranged at least partially in a first half of the projection, wherein the first half of the projection is closer to the pivot axis plane than a second half of the projection.

7. The cutting chain according to claim 1, wherein a length of the cutting element measured in the running direction is larger than a division of the cutting chain, wherein the division of the cutting chain is a distance, divided by 2, of a pivot axis to a next but one pivot axis of the pivot axes.

8. The cutting chain according to claim 7, wherein the length of the cutting element measured in the running direction corresponds to at least 1.05 times a length of the division of the cutting chain.

9. The cutting chain according to claim 1, wherein the cutting member comprises a central section extending in the running direction between two of the pivot axes connecting the cutting member to a leading one of the central drive links and a trailing one of the central drive links in the running direction, respectively, wherein the cutting element in the running direction projects past the central section in the running direction and opposite to the running direction.

10. The cutting chain according to claim 1, wherein the cutting element comprises a base body fixed to the two side members of the pair of two side members, wherein the base body forms a support for the cutting material.

11. The cutting chain according to claim 10, wherein the base body is comprised of steel.

12. The cutting chain according to claim 1, wherein the side members and the central drive links are connected to each other by collar studs, wherein the collar studs each comprises a collar arranged between the two side members of the pairs of two side members, respectively.

13. The cutting chain according to claim 1, wherein the cutting element comprises a base body and at least one centering section configured to secure a position of the base body in relation to at least one of the two side members of the pair of two side members in at least one direction parallel to the pivot axis plane.

14. The cutting chain according to claim 13, wherein the centering section secures the position of the base body in relation to at least one of the two side members of the pair of two side members in the transverse direction, wherein the centering section projects advantageously into a space between the two side members of the pair of two side members.

15. The cutting chain according to claim 13, wherein the centering section secures the position of the base body in relation to at least one of the two side members of the pair of two side members in the running direction.

16. The cutting chain according to claim 15, wherein the centering section projects into a recess arranged at least at one of the two side members.

17. The cutting chain according to claim 1, wherein the cutting material is a single layer of diamond.

18. The cutting chain according to claim 1, wherein a maximum distance of the cutting element to the pivot axis plane amounts to less than 1.4 times a length of the division of the cutting chain, wherein the division of the cutting chain is a distance, divided by 2, of a pivot axis to a next but one pivot axis of the pivot axes.

19. The cutting chain according to claim 18, wherein a maximum distance of the projections in relation to the pivot axis plane amounts to 0.8 to 1 times the maximum distance of the cutting element to the pivot axis plane.

20. A cutting chain for cutting mineral or metallic materials, the cutting chain comprising:
central drive links each comprising a projection;
pairs of two side members, respectively, wherein the two side members of the pairs of two side members are positioned laterally in relation to the central drive links, wherein the central drive links and the pairs of two side members are pivotably connected to each other so as to pivot about pivot axes, wherein the cutting chain comprises a transverse direction extending parallel to the pivot axes and further comprises a pivot axis plane connecting the pivot axes of the cutting chain when the cutting chain is pulled straight;
at least two cutting members arranged sequentially in a running direction of the cutting chain, wherein each of the at least two cutting members comprises one of the pairs of two side members and further comprising a cutting element configured to abrasively remove material, wherein the cutting element connects the two side members of the pair of two side members to each other;
wherein the central drive links include a drive link arranged between the at least two cutting members, wherein the projection of the drive link arranged between the at least two cutting members projects into a space between the cutting elements of the at least two cutting members;
wherein the cutting element comprises at least one centering section that secures the position of a base body of the cutting element in relation to at least one of the two side members of the pair of two side members in at least one direction parallel to the pivot axis plane.
